(19) United States
(12) Patent Application Publication
(10) Pub. No.: US 2015/0276096 A1
(43) Pub. Date: Oct. 1, 2015

(54) MICRODUCT FOR BLOWN CABLE

(71) Applicant: Verizon Patent and Licensing Inc., Arlington, VA (US)

(72) Inventor: David Z. CHEN, Richardson, TX (US)

(73) Assignee: Verizon Patent and Licensing Inc., Arlington, VA (US)

(21) Appl. No.: 14/230,948

(22) Filed: Mar. 31, 2014

(51) Int. Cl. F16L 11/12; H02G 3/04; H02G 1/08; F16L 11/127

(52) U.S. Cl. CPC F16L 11/121; F16L 11/12; F16L 11/127; H02G 3/04; H02G 1/086

(57) ABSTRACT

A duct construction, such as a microduct, for deploying various types of cables is disclosed. The duct includes a plurality of protrusions that are formed on its inner surface. The protrusions extend the entire length of the duct in order to reduce and/or eliminate blockages that can result from contact with the cable over extended distances. This allows air from a jetting device to travel unimpeded through the duct, thereby improving cable deployment range and time.

### BACKGROUND INFORMATION

Technological advances require continual upgrades to existing infrastructures in order to keep up with consumer demands for the latest features and services. One such infrastructure upgrade involves migration of voice and data communication services from metal (e.g., copper, aluminum, coaxial, etc.) to optical fiber (also referred to as fiber optics or simply fiber), as well as improvements in existing optical fiber lines. Further improvements also involve upgrades to replace existing optical fiber lines for improved capacity and/or reliability. In order to upgrade the infrastructure in this manner, it is necessary to first deploy the optical fiber cable from central hubs to various locations such as office buildings, apartment buildings, single/multi-family homes, etc.

It is therefore necessary to deploy the optical fiber lines underground and/or remove legacy cables. Additionally, installation within buildings requires passage of the optical fiber cables within existing structures, often without disturbing visible walls. This often involves complicated routes having numerous turns. Optical fiber cables, however, are more difficult to deploy than conventional cables. Furthermore, it is necessary to route the optical fiber cable through a duct, such as a microduct, using specialized machinery. The multiple curves can result in increased friction between the optical fiber cable and the duct, thereby limiting the distance that the optical fiber can be deployed before the machinery must be moved forward to continue deployment. The limited distance and repeated movement of the machinery can extend the length of time required for deployment. This can also present problems in urban localities that have regulations regarding the hours during which infrastructure projects can be conducted, and require completion of such projects within strict time limits.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a duct for blowing cables, according to one embodiment;

FIG. 2 is a diagram of a duct for blowing cables, according to another embodiment;

FIG. 3 is a cross-sectional view illustrating a cable within a duct, according to one embodiment;

FIG. 4 is a diagram of a splice termination system for ducts, according to one embodiment;

FIG. 5 illustrates a system for deploying cables using a duct constructed in accordance with one embodiment; and

FIG. 6 is a flowchart of a process for using a duct to deploy cables, according to one embodiment.

### DESCRIPTION OF THE PREFERRED EMBODIMENT

A duct, and method and system for deploying cables using the duct, are described. In the following description, for the purposes of explanation, numerous specific details are set forth in order to provide a thorough understanding of the described embodiments. It is apparent, however, to one skilled in the art that various embodiments may be practiced without these specific details or with an equivalent arrangement. In other instances, well-known structures and devices are shown in block diagram form in order to avoid unnecessarily obscuring the described embodiments.

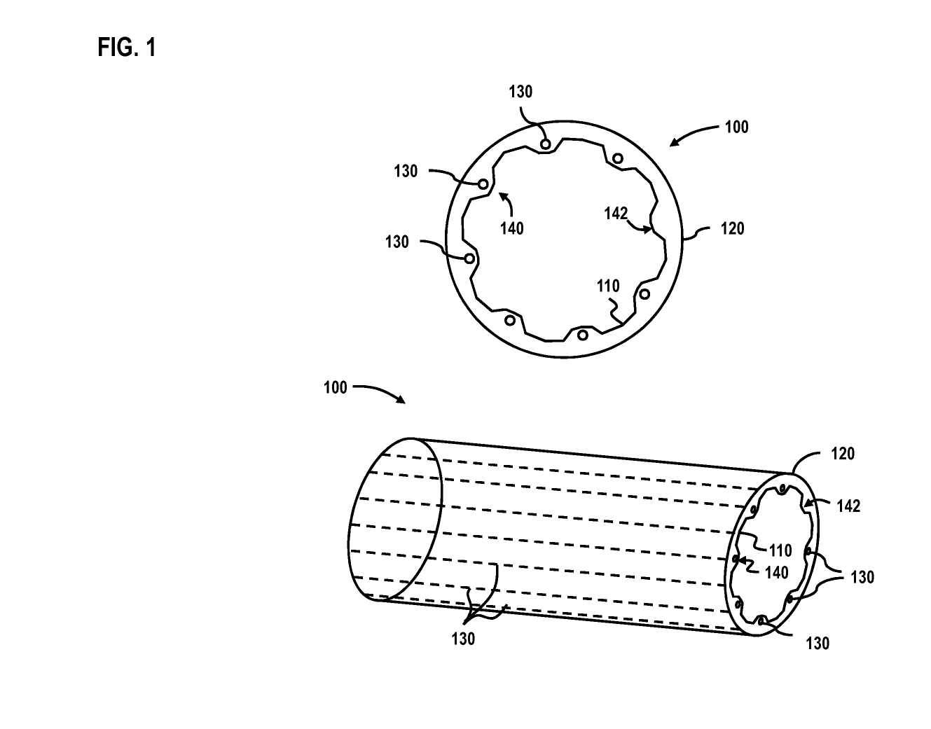

FIG. 1 illustrates a duct 100, such as a microduct, for blowing cables, according to one embodiment. The duct 100 includes an inner surface 110 and an outer surface 120. The distance between the inner surface 110 and the outer surface 120 further defines a thickness along the cross-section of the duct 100. As illustrated in FIG. 1, the duct 100 has a hollow interior which allows it to be used for deployment of various types of cables, as will be discussed in greater detail below. The duct 100 also includes one or more conductors 130 that are disposed, or embedded, between the inner surface 110 and the outer surface 120. Thus, according to at least one embodiment, the size (i.e., diameter) of the conductors 130 can be restricted depending on the thickness of the duct 100. The conductors 130 are constructed such that they extend along the entire length of the duct 100.

According to the embodiment illustrated in FIG. 1, each conductor 130 extends in a substantially parallel manner with respect to the axial axis of the duct 100. The conductors 130 are positioned at points closer to the inner surface 110 of the duct 100. The proximity of the conductors 130 to the inner surface 110 results, at least in part, in formation of protrusions 140 on the inner surface 110 at locations corresponding to the position of each conductor 130. According to other embodiments, however, the conductors 130 can be positioned at different locations along the thickness of the duct 100, while still allowing the protrusions 140 to be formed. The protrusions 140 also extend along the entire length of the duct 100 in relation to the conductors 130.

One or more embodiments provide for additional protrusions 142 to be formed on the inner surface 110 without corresponding to a conductor 130. For example, the duct 100 can be configured without any conductors 130, or with a reduced number of conductors 130 (e.g., one, two, three, etc.) relative to protrusions. As illustrated in FIG. 1, the duct 100 can include seven conductors 130. Seven protrusions 140, however, are provided at locations corresponding to the conductors 130. An additional protrusion 142 is provided at a location that does not correspond any conductors 130. More particularly, the duct 100 can be configured three conductors 130 and five protrusions 140, two conductors 130 and eight protrusions 140, etc. The embodiment is therefore only intended to be illustrative, and not restrictive. Rather, any desired combination of conductor/protrusion can be used in the duct 100. Additionally, the protrusions 140, 142 are not limited to any particular shapes or configuration. They can have uniform or non-uniform curvatures, flat portions, multiple edges, or any combination thereof.

According to one or more embodiments, the conductors 130 can be used for grounding, supplying power, generating one or more ring tone frequencies, providing a completed circuit, or a combination thereof. For example, the conductors 130 can be in the form of a single strand of conductive material, or a twisted pair of conductive material. According to at least one embodiment, the use of a twisted pair of conductive material can facilitate a complete circuit by allowing one wire to function as a positive conductor and the other wire to function as a negative conductor. The conductors 130 can be arranged in various patterns including symmetrical and non-symmetrical.

According to at least one embodiment, the protrusions 140 assist in deployment cables by allowing a consistent and continuous flow of air through the duct 100. More particularly, the duct 100 must be passed through various obstacles which cause varying degrees of curvature at different directions, as well as elevation changes. When deploying the cable, such changes in the orientation of the duct 100 result in establishment of contact areas between an outer surface 120 of the cable and the inner surface 110 of the duct 100. As the cable encounters increasing changes in direction, contact with the duct 100 also increases. Over extended deployment lengths, significant contact can be established between the cable and the duct 100, thus resulting in a decrease, or complete blockage, in the flow of air through the duct 100. According to various embodiments, however, the flow of air through the duct 100 can be maintained throughout the deployment route regardless of the level of contact between the duct 100 and the cable.

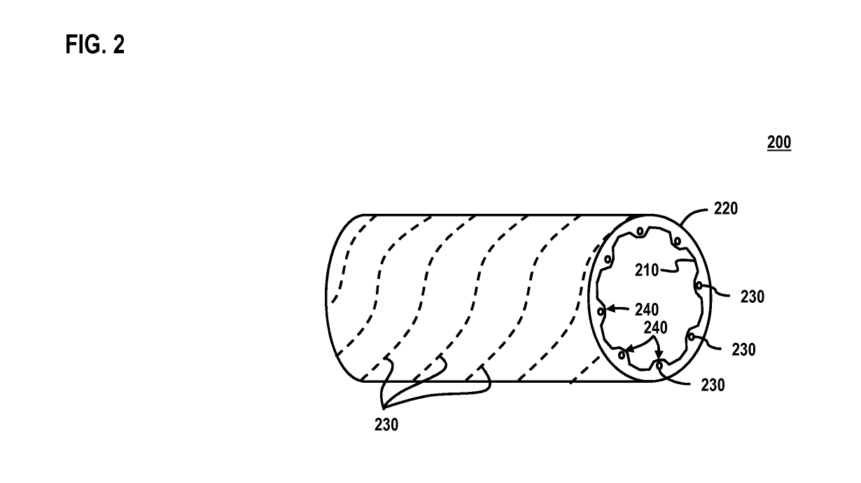

FIG. 2 illustrates a duct 200 according to another embodiment. The duct 200 includes an inner surface 210 and an outer surface 220, which define a thickness for the duct 200. One or more conductors 230 are provided between the inner surface 210 and the outer surface 220 of the duct 200. According to the embodiment illustrated in FIG. 2, the conductors 230 can be oriented in a circular pattern, such as a rifling-type pattern, around the duct 200. More particularly, the conductors 230 are circumferentially disposed with a predetermined period. Thus, when viewed from an axial direction, each conductor 230 travels a circumferential distance within the thickness of the duct 200. The circumferential distance is completed within a predetermined length of the duct 200, and repeats continually. Accordingly, the arrangement of the wires 230 around the duct 220 is not limited to the rifling-type pattern shown in FIG. 2. Rather, various configurations can be used. For example, the period or distance travelled along the length of the duct 230 per rotation (e.g., loop or coil around the duct) can be fixed or it can be variable, certain portions can be vertical or horizontal, etc. Any desired arrangement can therefore be used.

A protrusion 240 is formed on the inner surface 210 of the duct 200 at locations corresponding to each conductor 230. Accordingly, the protrusions 240 reflect the same circular, or a rifling, pattern around the inner surface 210 of the duct 200. As previously discussed, the conductors 230 can be used for grounding, supplying power, generating one or more ring tone frequencies, providing a completed circuit, or a combination thereof. Furthermore, the conductors 230 can be arranged in various patterns including symmetrical and non-symmetrical. In addition to maintaining and improving airflow within the duct 200 during deployment of conventional cables, similar results can be achieved when deploying non-conventional cables. For example, the rifling pattern allows cables having external grooves to be used with the duct 200, without causing blockages which could result from the grooves being pressed over the protrusions 240 as a result of turning or bending.

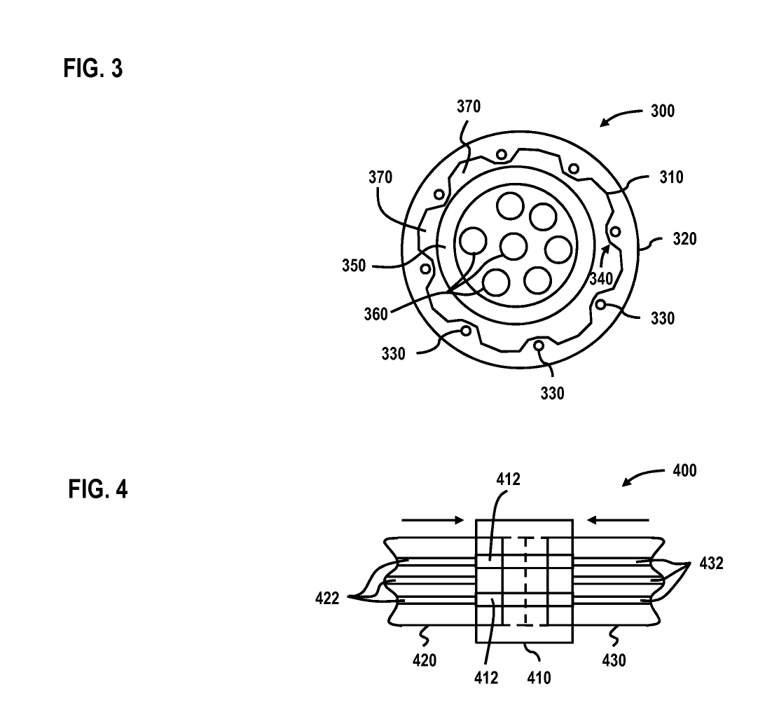

FIG. 3 is a cross sectional view illustrating a cable 350 inside a duct 300, according to at least one embodiment. The duct 300 includes an inner surface 310 and an outer surface 320 which define its thickness. One or more conductors 330 are disposed between the inner surface 310 and the outer surface 320 of the duct 300. A plurality of protrusions 340 are correspondingly formed on the inner surface 310 of the duct 300 at locations where the conductors 330 are located. As illustrated in FIG. 3, the cable 350 has been inserted within the duct 300 for deployment. The cable 350 can include a plurality of signal lines 360 that can be used, for example, to transmit data, voice, control signals, etc.

During deployment, the cable 350 is typically advanced through the duct 300 using, for example, a jetting apparatus. Air is forced within the duct 300 at a predetermined pressure. The airflow, in part, causes the cable 350 to be advanced through the duct 300. As the length of deployment increases, however, the cable 350 would contact a conventional duct at various locations, thereby restricting or stopping the flow of air. According to at least one embodiment, however, the protrusions 340 formed on the inner surface 310 of the duct 300 function, at least in part, to maintain a continuous flow of air.

For example, when the cable 350 contacts the inner surface 310 of the duct 300, airflow passages 370 are formed between the cable 350 and adjacent protrusions 340. Since the protrusions 340 extend the entire length of the duct 300, the airflow passages 370 are formed at any position where the cable 350 would contact the inner surface 310 of the duct 300. According to an embodiment, the airflow passages 370 also allow the pressure within the duct 300 to be increased without risking damage to the jetting apparatus, because blockages will not be formed. Furthermore, by increasing the pressure and airflow within the duct 300, the cable 350 can be forced to the center of the duct 300 (i.e., float), thereby reducing friction that would result from contact against the inner surface 310 of the duct 300. This allows the cable 350 to be deployed quickly, and extends the range for deploying the cable 350.

FIG. 4 illustrates a splice termination system 400 for connecting ducts, in accordance with at least one embodiment. The splice termination system 400 allows two ducts to be joined together for deploying the cable, while maintaining both physical and electrical continuity. More particularly, the splice termination system 400 allows a first duct 420 to be joined with a second duct 430. This can be accomplished by means of a friction fit, clamps, adhesives, fusion, etc. A splicing unit 410 is used to secure the first duct 420 and the second duct 430 together. According to an embodiment, the splicing unit 410 can further allow first conductors 422 disposed within the first duct 420 to contact second conductors 432 disposed within the second duct 430, thereby maintaining electrical continuity. Thus, extended routes may be created by joining multiple sections of the duct. Furthermore, when the deployment limit of the cable is reached and the jetting apparatus is advanced, the duct can be reconnected with both physical and electrical continuity.

According to an embodiment, the splicing unit 410 can include one or more alignment marks 412 which allow the first conductors 422 to be aligned with the second conductors 432. According to other embodiments, the outer surface of the ducts can include markings corresponding to the position of conductors. Accordingly, the markings on the ducts can be used in conjunction with the alignment marks 412 on the splicing unit 410 such that the first conductors 422 and second conductors 432 contact each other when the first and second ducts (420, 430) are inserted within the splicing unit 410. Additionally, the alignment marks 412 can be configured as clear (i.e., see through) alignment marks which allow visual confirmation of the markings on the ducts. According to further embodiments, the first and second ducts (420, 430) can include grooves or protrusions at various locations on the outer surface. Such grooves, for example, can be configured to engage protrusions within the splicing unit 410 so that the first conductors 422 can be aligned with the second conductors 432. According to an embodiment, the splicing unit 410 can be configured such that the protrusion for engaging the grooves on the first duct 420 and the second duct 430 can be adjusted. Accordingly, the splicing unit 410 would be capable of adjustment in order to join a variety of pairs of ducts such as, for example, two ducts having 8 conductors, two ducts having 12 conductors, two ducts having 15 conductors, etc.

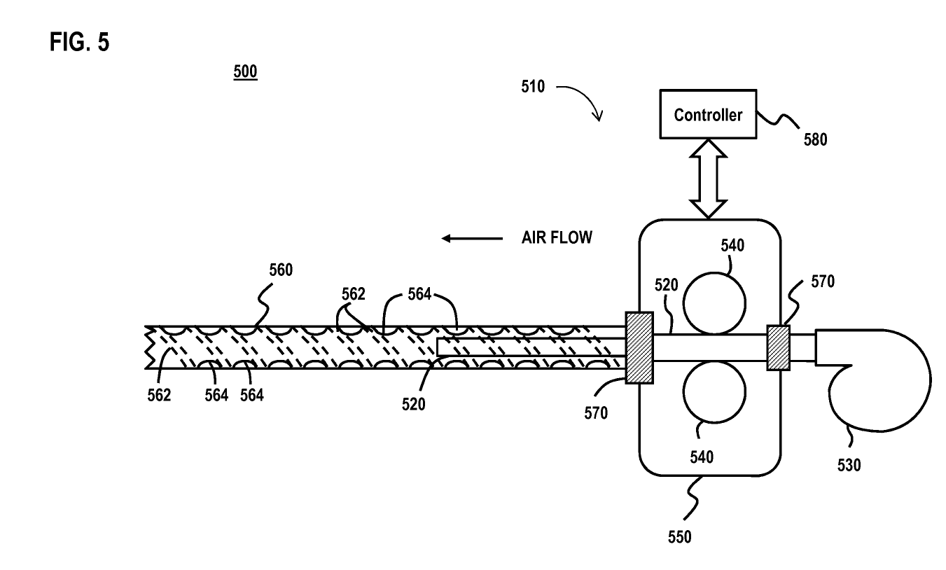

FIG. 5 illustrates a system 500 utilizing a jetting apparatus 510 for deploying a cable 520, in accordance with at least one embodiment. By way of example, such a jetting apparatus 510 can include a cable dispenser 530 which houses a spool of the necessary cable 520 and one or more rollers 540 to feed the cable 520 through the duct 560. The rollers 540 are contained in a housing 550 which is pressurized to generate an air jet within the duct 560. One or more seals 570 can be provided to maintain a required pressure as air is blown into the duct 560. According to the illustrated embodiment, the duct 560 contains a plurality of conductors 562 that are arranged in a rifling pattern. A plurality of protrusions 564 are formed on the inner surface of the duct 560 at locations corresponding to the conductors 562. Accordingly, the protrusions 564 form a rifling pattern within the inner surface of the duct 560, thereby allowing air to flow continuously along the length of the duct 560.

According to at least one embodiment, a controller 580 can also be provided for monitoring operation of the jetting apparatus 510. The controller 580 can be used, for example to monitor the air pressure within the housing 550 and duct 520 in order to facilitate continuous deployment of the cable 520. Furthermore, the controller 580 can control operation of the rollers 540 and dispenser 530 to vary the speed at which cable 520 is dispensed. According to an embodiment, the controller 580 can control operation of the jetting apparatus 510 so that the cable 520 is dispensed at a velocity that is appropriate for the air pressure. For example, if the air pressure and/or velocity within the duct 560 drops below a predetermined level, it may be necessary to decrease the rate of deployment for the cable 520. Alternatively, it may be necessary to increase the airflow and/or pressure. Although a controller 580 is illustrated in FIG. 5, it should be noted that various other devices, such as a personal computer, laptop, special purpose computing unit, etc. can be programmed and configured for appropriately controlling operation of the jetting apparatus 510.

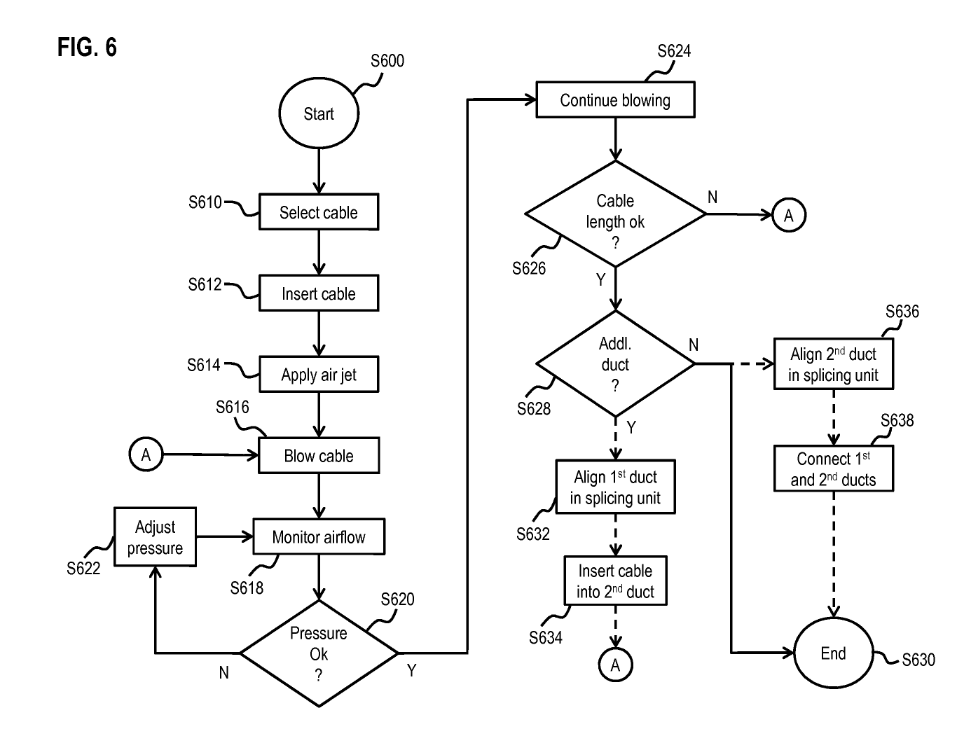

FIG. 6 is a flowchart illustrating deployment of a cable within a duct in accordance with at least one embodiment. The process begins at S600. At S610, and appropriate cable is selected for deployment within the duct. The cable can be selected, for example, based on its diameter, weight, design, etc. For example, the cable diameter can be limited due to the size of the duct. Therefore, a predetermined maximum diameter can be set for the cable with respect to a particular duct. Similarly, the weight of the cable can affect its selection depending, for example, on the length of deployment.

At S612, the cable is inserted into the duct. As previously discussed, a jetting apparatus can be used for blowing and/or pushing the cable through the duct. The jetting apparatus is then activated, and an air jet is applied at S614. The air jet can be provided at predetermined pressures to blow the air at a desired velocity. At S616, the cable is blown through the duct, while the rollers supply an additional length of the cable. As previously discussed, various embodiments provide protrusions on the inner surface of the duct. The protrusions allow improved airflow through the duct and around the cable. Furthermore, if the cable contacts the duct, airflow passages are created so that airflow is maintained.

At S618, the airflow is monitored in order to determine various information indicative of the status of the deployment activity such as velocity, pressure, etc. According to one or more embodiments, the airflow can be continuously monitored and adjusted to maintain desired values. According to other embodiments, the airflow can be monitored at specific intervals or through manual operations. At S620, it is determined whether the air pressure is sufficient for the current deployment distance. If the pressure is insufficient, then control passes to S622 where the air pressure is adjusted. Depending on the particular circumstances and results of monitoring the airflow, the pressure may be increased or decreased. The pressure can therefore be increased or decreased, depending on the particular condition detected, in order to optimize the airflow. According to an embodiment, the controller can be operatively connected to the jetting apparatus in order to regulate the airflow and/or pressure, as well as the rate of speed at which the cable is being deployed. Once the pressure has been adjusted, the process returns to S618 where the airflow is again monitored. If, however, the pressure is determined to be adequate, then control passes to S624 where the jetting apparatus continues to blow the cable through the duct.

At S626, it is determined whether the desired length of cable has been deployed. If the desired length of cable has not been reached yet, then control passes to S616 where the cable continues to be blown through the duct. Optionally, control can pass to S624 if the pressure is determined to ok, or if the controller continuously monitors the pressure within the jetting apparatus and the duct. In such embodiments, the controller can be configured to interrupt the process and pass control to S622. If the desired length of cable has been deployed, however, control passes to S628.

According to at least one embodiment, the deployment route may exceed the distance limitations of the jetting apparatus. For example, the deployment route may be 8 miles, whereas the jetting apparatus may have a limitation of 4 miles for the particular duct/cable combination. It may therefore be necessary to deploy the cable in 4 mile intervals using, for example, two ducts and subsequently rejoining the ducts upon completion of the entire deployment process. Accordingly, at S628, it is determined whether additional segments of the duct must be traversed, or used, in order to complete the deployment process. If additional ducts are not required, then control passes to S630, where the process ends.

If additional segments are required, then control passes to S628 where the first duct is aligned, for example, within a splicing unit. The cable is then inserted within the second duct (e.g., additional duct segment) at S634. As previously discussed, the exemplary embodiment requires two iterations of deployment (e.g. 4 miles+4 miles) in order to achieve the 8 mile deployment distance. The cable would therefore need to be blown through the second duct segment. Control passes to S616, where the blowing process performed through S626 until the cable length is determined to be sufficient.

According to the exemplary embodiment, the cable has now been deployed the entire 8 mile distance. Therefore, when control returns to S628, it would be determined that no additional duct segments are required. Rather than completing the process, as with the case where only a single duct is required, control would instead pass to S636. The second duct can then be aligned within the splicing unit. At S638, the first and second ducts are connected via the splicing unit. The process then ends at S634.

According to other embodiments, it may be necessary to utilize additional duct segments in order to complete the deployment route. For example, if the deployment route is 16 miles, two additional duct segments would be required for a total of four. In such embodiments, the process would not end upon connecting the first and second ducts at S638. Rather, control would optionally pass to S632 again, with an iteration corresponding to the next duct segment. More particularly, the second duct would be aligned within a second splicing unit. Similarly, at S634, the cable would be inserted into the third duct so that the blowing process can be repeated. The second duct would then be joined with the third duct using the second splicing unit. The procedure can optionally continue until all necessary duct segments have been utilized to complete the deployment route.

In the preceding Specification, various preferred embodiments have been described with reference to the accompanying drawings. It will, however, be evident that various modifications and changes may be made thereto, and additional embodiments may be implemented, without departing from the broader scope of the invention as set forth in the claims that follow. The Specification and drawings are accordingly to be regarded in an illustrative rather than restrictive sense.

What is claimed is:

1. A duct comprising:
an inner surface and an outer surface, the duct having a hollow interior for accommodating a cable;
at least one conductor disposed between the inner surface and the outer surface; and
a plurality of protrusions formed on the inner surface, at least one of the plurality of protrusions being formed at a location corresponding to the at least one conductor,
wherein the plurality of protrusions extend along an entire length of the duct.

2. A duct of claim 1, wherein the at least one conductor comprises one or more twisted pair conductors.

3. A duct of claim 1, wherein the at least one conductor extends parallel to an axial direction of the duct.

4. A duct of claim 1, wherein the at least one conductor extends along the length of the duct in a rifling pattern.

5. A duct of claim 1, wherein the at least one conductor is configured for grounding, supplying power, generating one or more ring tone frequencies, providing a completed circuit, or a combination thereof.

6. A method comprising:
receiving, within a duct, a first end of a cable, the duct including at least one conductor disposed between an inner surface and an outer surface thereof and a plurality of protrusions formed on the inner surface;
applying an air jet at a predetermined pressure through a first end of the duct using a jetting apparatus; and
blowing the cable toward a second end of the duct,
wherein:
at least one of the plurality of protrusions is formed at a location corresponding to the at least one conductor,
the plurality of protrusions extend along an entire length of the duct, and
the predetermined pressure and plurality of protrusions facilitate a continuous flow of air between the first and second ends of the duct.

7. A method of claim 6, further comprising grounding the duct using at least one of the at least one conductor.

8. A method of claim 6, further comprising supplying power through at least one of the at least one conductor.

9. A method of claim 6, further comprising supplying one or more ring tone frequencies through the at least one conductor.

10. A method of claim 6, further comprising disposing the at least one conductor in a rifling pattern.

11. A method of claim 6, further comprising joining a second duct with the duct using a splicing unit.

12. A method of claim 11, wherein the splicing further comprises:
aligning the at least one conductor in the duct with at least one conductor in the second duct;
inserting the duct into a first end of the splicing unit;
inserting the second duct into a second end of the splicing unit; and
securing the first duct and the second duct within the splicing unit,
wherein the first duct contacts the second duct, and the at least one conductor in the first duct contacts the at least one conductor in the second duct.

13. A system comprising:
a duct extending a predetermined length, and including:
an inner surface, an outer surface, and a hollow interior for accommodating a cable;
at least one conductor disposed between the inner surface and the outer surface; and
a plurality of protrusions formed on the inner surface, at least one of the plurality of protrusions being formed at a location corresponding to the at least one conductor, and extending along an entire length of the duct;
a cable having a first end inserted into a first end of the duct, and containing one or more signal lines capable of transmitting data, voice, and/or control signals; and
a jetting apparatus attached to the first end of the duct for supplying an air jet at a predetermined pressure and blowing the cable toward a second end of the duct,
wherein the predetermined pressure and plurality of protrusions facilitate a continuous flow of air between the first and second ends of the duct.

14. A system of claim 13, wherein the at least one conductor comprises one or more twisted pair conductors.

15. A system of claim 13, wherein the at least one conductor extends parallel to an axial direction of the duct.

16. A system of claim 13, wherein the at least one conductor extends along the length of the duct in a rifling pattern.

17. A system of claim 13, wherein the at least one conductor is configured for grounding, supplying power, generating one or more ring tone frequencies, providing a completed circuit, or a combination thereof.

18. A system of claim 13, further comprising a splicing unit for joining a second duct with the duct.

19. A system of claim 18, wherein the second duct includes at least one conductor disposed between an inner surface and an outer surface thereof.

20. A system of claim 19, wherein the splicing unit includes one or more alignment marks for aligning the at least one conductor of the duct with the at least one conductor of the second duct.
